(19) United States
(12) Patent Application Publication
(10) Pub. No.: US 2019/0163010 A1
(43) Pub. Date: May 30, 2019

(54) REFLECTIVE DISPLAY DEVICE AND SELECTIVE DISPLAY DEVICE HAVING THE SAME

(71) Applicant: SAMSUNG ELECTRONICS CO., LTD., Suwon-si, Gyeonggi-do (KR)

(72) Inventors: Sang Hyun SOHN, Suwon-si, Gyeonggi-do (KR); Ki Hyung KANG, Suwon-si, Gyeonggi-do (KR)

(21) Appl. No.: 16/320,688

(22) PCT Filed: Jun. 1, 2017
(86) PCT No.: PCT/KR2017/005741

§ 371 Date: Jan. 25, 2019

(30) Foreign Application Priority Data
Jul. 26, 2016 (KR) 10-2016-0094968

(51) Int. Cl. G02F 1/1335; G02F 1/133

(52) U.S. Cl. CPC G02F 1/133514; G02F 1/13318; G02F 1/133553

(57) ABSTRACT

Disclosed is a reflective display device including: two plates arranged to be separated from each other; a liquid crystal layer arranged between the two plates; a reflective plate arranged under the liquid crystal layer; and a color filter arranged on the top of the liquid crystal layer and configured to selectively transmit a predetermined color of light, wherein the color filter has a bandwidth wider than a half width of light that passes the color filter. In embodiments of the present disclosure, the reflectivity is increased by widening a passage bandwidth of the color filter instead of adjusting the thickness of the color filter, so that the power efficiency is improved and an image with high color purity may be expressed. Furthermore, it is possible to select between reflective mode and transmissive mode depending on the ambient environment, thereby providing goo quality of images to the user in a more stable manner.

### CROSS-REFERENCE TO RELATED APPLICATION

This application is based on and claims priority under 35 U.S.C. § 119 to Korean Patent Application No. 10-2016-0094968 filed on Jul. 26, 2016, in the Korean Intellectual Property Office, the disclosure of which is incorporated herein by reference in its entirety.

### BACKGROUND

### 1. Field of the Invention

The present disclosure relates to a reflective display device and a selective display device having the same, and more particularly, to a reflective display device and selective display device having the same attaining high efficiency and color purity by adjusting bandwidth of a color filter to increase the transmittance of the reflective display device. The present disclosure also relates to a technology of a selective display device having a property of the reflective display device and capable of selecting reflective mode and transmissive mode.

### 2. Discussion of Related Art

With a growing interest in displays today, various technologies are being developed to improve the performance of the display.

Instead of Cathode Ray Tubes (CRTs) that have been used for a long time since the traditional television broadcast began, very thin television sets, such as Liquid Crystal Display (LCD) or Plasma Display Panel (PDP) have been developed and are being practically used.

Especially, color LCD displays using color LCD panels are expected to be further advanced in the future because the color LCD displays are considered to be rapidly prevalent due to their low power consumption and decreasing prices of large color LCD panels.

The color LCD display often employs a backlighting method, i.e., a transmissive mode, in which a backlighting device illuminates the transmissive color LCD panel from the backside to display color images. However, as many applications, such as e-books, mobile devices, billboards, and the like need a display that can be operated at low power these days, reflective displays are being developed rapidly.

The reflective display refers to a non-emissive display that reflects ambient light back to the viewer from the display to deliver displayed information rather than having a light source behind the display to emit light to be transmitted through the display as in the conventional transmissive display.

The reflective display has good power efficiency because it only uses ambient light as source light and thus consumes much less energy than the backlit or emissive LCD display. Accordingly, the reflective display is commonly used in outdoor applications that are unable to make enough luminance or contrast.

Despite this, the reflective display has disadvantages in that the brightness is changed depending on the ambient lighting environment because it is not equipped with any self-luminous light source unlike the transmissive display device. Especially, the overall transmittance of the reflective display is only 5 to 7% due to polarization plates, color filters, aperture ratios, etc., so the screen is dark because of low reflectivity when the same technology is implemented by the reflective display.

To overcome this problem, a technology to improve panel reflectivity by increasing transmittance at all wavelengths by adjusting the thickness of color filters is used, which may increase the reflectivity but still has a problem of small color gamut.

### SUMMARY OF THE INVENTION

Therefore, it is an object of the present disclosure to provide a reflective display device and selective display device having the same, which increases transmittance and prevents degradation of color purity by adjusting bandwidth of a color filter rather than adjusting thickness of the color filter.

In accordance with an aspect of the present disclosure, a reflective display device includes two plates arranged to be separated from each other; a liquid crystal layer arranged between the two plates; a reflective plate arranged under the liquid crystal layer; and a color filter arranged on the top of the liquid crystal layer and configured to selectively transmit a predetermined color of light, wherein the color filter has a bandwidth wider than a half width of light that passes the color filter.

The color filter may include one of a red color filter, a green color filter, and a blue color filter.

The color filter may have transmittance of equal to or greater than about 50% and equal to or less than about 80% at a point where spectra of green light and red light that have passed the color filter cross.

The color filter may have transmittance of equal to or greater than about 50% and equal to or less than about 80% at a point where spectra of green light and blue light that have passed the color filter cross.

A bandwidth of the green color filter may be wider than a half width of green light that passes the green color filter, the bandwidth being equal to or greater than about 120 nm and equal to or less than 160 nm.

A bandwidth of the red color filter may be wider than a half width of red light that passes the red color filter, the bandwidth being equal to or greater than about 120 nm and equal to or less than 160 nm.

A bandwidth of the blue color filter may be wider than a half width of blue light that passes the blue color filter, the bandwidth being equal to or greater than about 120 nm and equal to or less than 160 nm.

In accordance with another aspect of the present disclosure, a selective display device includes two plates arranged to be separated from each other; a liquid crystal layer arranged between the two plates; a reflective plate arranged under the liquid crystal layer; and a color filter arranged on the top of the liquid crystal layer and configured to selectively transmit a predetermined color of light, wherein the color filter has a bandwidth wider than a half width of light that passes the color filter.

The reflective plate may be switched between a reflective mode in which the light is reflected and a transmissive mode in which the light is transmitted.

The selective display device may further include a measurer configured to measure a spectrum of light emitted from an external light source.

The selective display device may further include an illumination source arranged under the reflective plate and configured to supply light to the liquid crystal layer.

The selective display device may further include a controller configured to control intensity of the illumination source and operation of the reflective plate.

The controller may control the intensity of the illumination source and operation of the reflective plate according to a feature of the spectrum measured by the measurer.

The controller may switch the reflective plate into the reflective mode and power off the illumination source when determining that the feature of the spectrum measured by the measurer corresponds to a first type.

The controller may switch the reflective plate into the transmissive mode and power on the illumination source when determining that the feature of the spectrum measured by the measurer corresponds to a second type.

The selective display device may further include: a selector configured to allow a user to select intensity of the illumination source and operation of the reflective plate.

The illumination source may include a light emitting diode (LED) or laser.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a configuration of a reflective display device, according to an embodiment of the present disclosure;

FIG. 2 shows a transmission spectrum of red, green, and blue light that has been transmitted through a color filter;

FIG. 3 shows a transmission spectrum of red, green, and blue light that has been transmitted through a color filter with adjusted thickness;

FIG. 4 shows a procedure in which human eyes sense the color of an object;

FIG. 5 shows a spectrum of wavelengths sensed by human eyes resulting from an ambient light spectrum and a reflection spectrum of an object;

FIG. 6 shows a transmission spectrum of red, green, and blue light that has been transmitted through a color filter whose bandwidth are adjusted to be wide, according to an embodiment of the present disclosure;

FIG. 7 shows a transmission spectrum of light with high RGB color purity;

FIG. 8 shows a spectrum of light expressed outwardly from a reflective display device having a color filter whose thickness is adjusted;

FIG. 9 shows a spectrum of green light expressed outwardly from a reflective display device whose bandwidth is adjusted to be wide, according to an embodiment of the present disclosure;

FIG. 10 shows a spectrum of red light expressed outwardly from a reflective display device whose bandwidth is adjusted to be wide, according to an embodiment of the present disclosure;

FIG. 11 shows a spectrum of blue light expressed outwardly from a reflective display device whose bandwidth is adjusted to be wide, according to an embodiment of the present disclosure;

FIG. 12 shows a general spectrum of light expressed outwardly from a reflective display device whose bandwidth is adjusted to be wide, according to an embodiment of the present disclosure;

FIG. 13 shows an internal configuration of a selective display device, according to an embodiment of the present disclosure; and

FIG. 14 is a block diagram of a selective display device, according to an embodiment of the present invention.

### DETAILED DESCRIPTION OF EXEMPLARY EMBODIMENTS

Embodiments and features as described and illustrated in the present disclosure are only preferred examples, and various modifications thereof may also fall within the scope of the disclosure.

The terminology used herein is for the purpose of describing particular embodiments only and is not intended to limit the present disclosure. It is to be understood that the singular forms “a,” “an,” and “the” include plural references unless the context clearly dictates otherwise.

It will be further understood that the terms “include”, “comprise” and/or “have” when used in this specification, specify the presence of stated features, integers, steps, operations, elements, and/or components, but do not preclude the presence or addition of one or more other features, integers, steps, operations, elements, components, and/or groups thereof.

The terms including ordinal numbers like “first” and “second” may be used to explain various components, but the components are not limited by the terms. The terms are only for the purpose of distinguishing a component from another. Thus, a first element, component, region, layer or section discussed below could be termed a second element, component, region, layer or section without departing from the teachings of the present disclosure. Descriptions shall be understood as to include any and all combinations of one or more of the associated listed items when the items are described by using the conjunctive term “˜ and/or ˜,” or the like.

To help an ordinary person in the art easily practice the present disclosure, embodiments of the present disclosure will now be described with reference to accompanying drawings.

To clarify several layers and pixel areas of the present disclosure, the thickness of them are exaggerated in the drawings. When a part of a layer, film, pixel area, plate, or the like is said to be on other part, it implies there may be an intermediate part between the two parts as well as the part is directly on top of the other part.

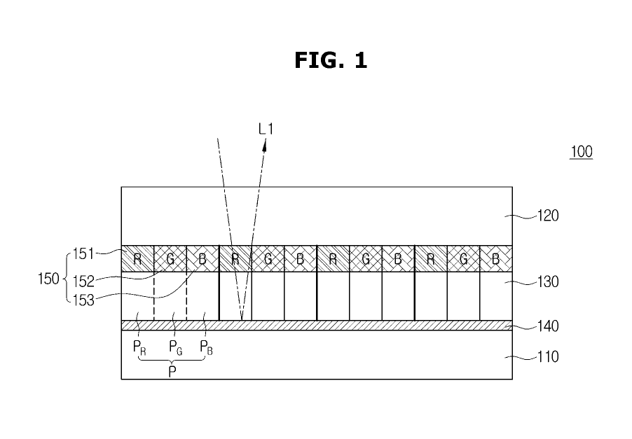

FIG. 1 is a configuration of a reflective display device, according to an embodiment of the present disclosure.

Referring to FIG. 1, a reflective display device 100 may include an upper plate 110 and a lower plate 120, which are arranged to be separated from each other, a liquid crystal layer 130 arranged between the upper plate 110 and the lower plate 120, a reflective plate 140 arranged under the liquid crystal layer 130, and a color filter 150 arranged on the top of the liquid crystal layer 130 for selectively transmitting predetermined colors of light.

The upper plate 110 and the lower plate 120 may be formed of plastic with good heat resistant and durability. They are not, however, limited thereto, and the upper plate 110 and the lower plate 120 may be formed to include various substances such as metal or glass.

The liquid crystal layer 130 may be located between the upper plater 110 and the lower plate 120. Although not shown, the liquid crystal layer 130 may be divided into a plurality of pixels P, which may be individually on- or off-controlled by pixel electrodes or thin film transistors (TFTs). The pixel electrodes or TFTs may allow the plurality of pixels P to transmit or block light.

Each pixel P may include a plurality of sub-pixels to make color images. For example, each pixel P may include red, green, and blue sub-pixels Pr, Pg, and Pb.

Mixing of red, green, and blue colors may generally express any color, and accordingly, filters of the three colors are mainly used without being limited thereto.

While it is assumed in the following embodiments that the pixel of the display device is comprised of red, green, and blue sub-pixels, it is not limited thereto and the pixel may be comprised of e.g., yellow, magenta, and cyan sub-pixels in some other embodiments. Besides, other various colors of sub-pixels may be implemented to express various colors.

Under the upper plate 110, there may be a plurality of filter areas 150 arranged to correspond to the plurality of pixels P. Each of the plurality of filter areas 150 may include sub-filters corresponding to the red, green, and blue sub-pixels, i.e., a red filter R 151, a green filter G 152, and a blue filter B 153.

Regarding how the reflective display device 100 operates in connection with FIG. 1, when external light L1 enters into the filter area 150, the light in the wavelength bands corresponding to the sub-filter areas 151, 152 and 153 is transmitted while the light in the other wavelength bands is absorbed, thereby forming red R, green G, and blue B light. The red R, green G, and blue B light may or may not be transmitted through the liquid crystal layer 130 depending on the liquid crystal layer 130 being electrically controlled to be on or off.

The light transmitted through the liquid crystal layer 130 may be reflected by the reflective plate 140 arranged under the lower area 120. The reflected layer is transmitted back through the liquid crystal layer 130 and the filter area 150 to the outside. Such reflected light may express a color image.

As described above, the reflective display device has an advantage of being efficiently operated at low power by expressing an image using external light, but the advantageous property leads to a disadvantage that the brightness is changed depending on the lighting environment of the external light.

Especially, the overall transmittance of the reflective display device is only about 5 to 7% due to the polarization panels, color filters, aperture ratio, etc., so the screen is dark because of low reflectivity when the same technology is implemented in the reflective display device. To solve this problem, a technology is used to improve the reflectivity by adjusting the thickness of the color filters.

In the following description and associated drawings, problems of the technology and the feature of the present disclosure to solve the problems will be reviewed.

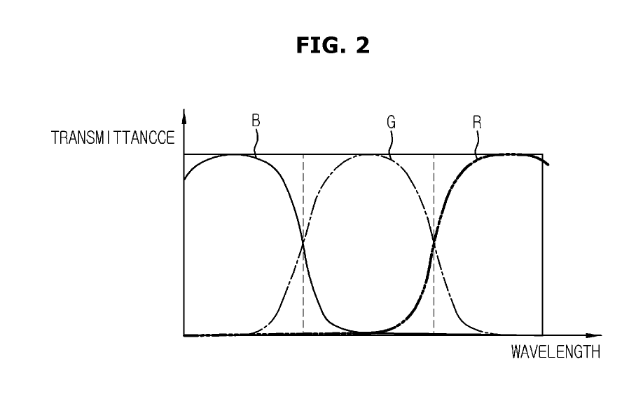

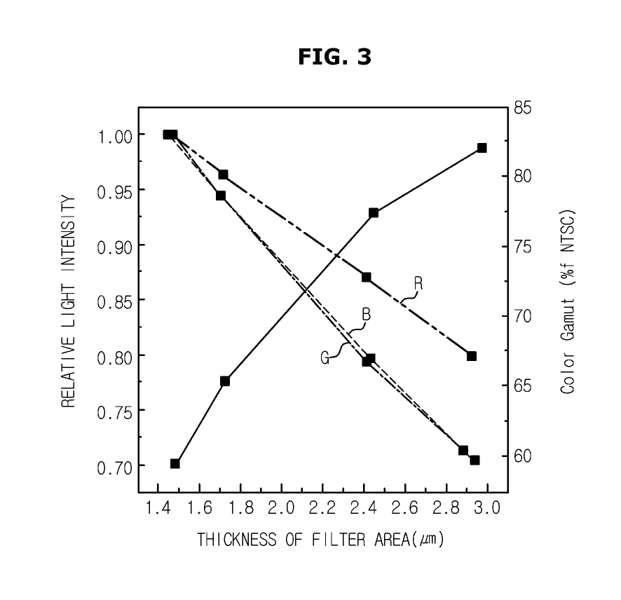

FIG. 2 shows a transmission spectrum of red, green, and blue light that has been transmitted through a color filter that is not subjected to any particular modification, and FIG. 3 shows a transmission spectrum of red, green, and blue light that has been transmitted through a color filter with the thickness adjusted.

Referring to FIG. 2, source light that has been transmitted through a color filter may be divided into red light, green light, and blue light. Furthermore, it may be seen that the transmittance of each color of light that has passed the color filter is reduced as it becomes farther from the center wavelength of the color of light. In this case, color purity is good because the transmittance becomes low in other wavelength bands, but the sharp decline in transmittance makes the overall transmittance of the filter lowered and thus leads to poor power efficiency.

In addition, the reflective display device expresses images using external light which passes the filter twice by nature so that the transmittance of the reflective display device is lower than that of the transmissive display device. The power efficiency of the reflective display device is only about 5 to 7%.

Since the overall transmittance of the reflective display device is only about 5 to 7% due to polarization plates, color filters, aperture ratios, etc., the screen is dark because of low reflectivity when the same technology is implemented by the reflective display. Conventional technologies address this problem in a method of improving the reflectivity by adjusting thickness of the color filter.

FIG. 3 shows a spectrum of light that has passed a color filter with thickness adjusted.

Referring to FIG. 3, the transmittance of individual colors of light decreases as it becomes farther from the center wavelength as in the color filter shown in FIG. 2, but unlike FIG. 2, the transmittance does not decrease entirely but remains at a certain level.

In this case, absorptivity of the color filter decreases, leading to a rise in overall transmittance in the transmission spectrum and an increase in power efficiency, but color purity is lowered because a certain amount of light is transmitted at all wavelengths to express even a single color.

Accordingly, the present disclosure is to solve this problem and maintain high reflectivity and efficiency as well as attain high color purity. Embodiments of the present disclosure will now be described in detail in connection with accompanying drawings.

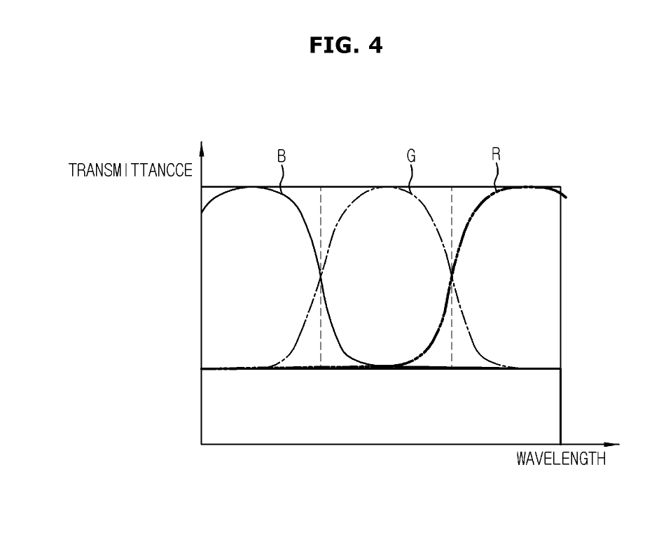

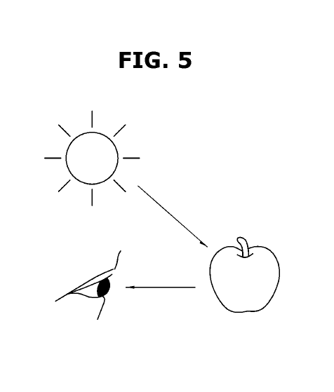

FIGS. 4 and 5 show a procedure in which human eyes sense the color of an object.

In a general procedure in which human eyes sense the color, as shown in FIG. 4, when light is incident on an object, the person recognizes the color from the reflected light according to a reflection spectrum of the object. The color that the person recognizes is determined by multiplication of a unique reflection spectrum of the object and a spectrum of external source light. It implies that even for the same object, the color of the object may be recognized differently according to the spectrum of the external source light.

A reflective display device also recognizes a color of an object from the reflected light according to a reflection spectrum of the object when light is incident on the object from a lighting source, in the same manner as the human recognizes the color of an object.

Specifically, the color on a reflective display may be determined by multiplication of a reflection spectrum of the object and a spectrum of the lighting source. Accordingly, the present disclosure is characterized by using this principle to increase color purity of the reflective display device based on a spectrum of external source light.

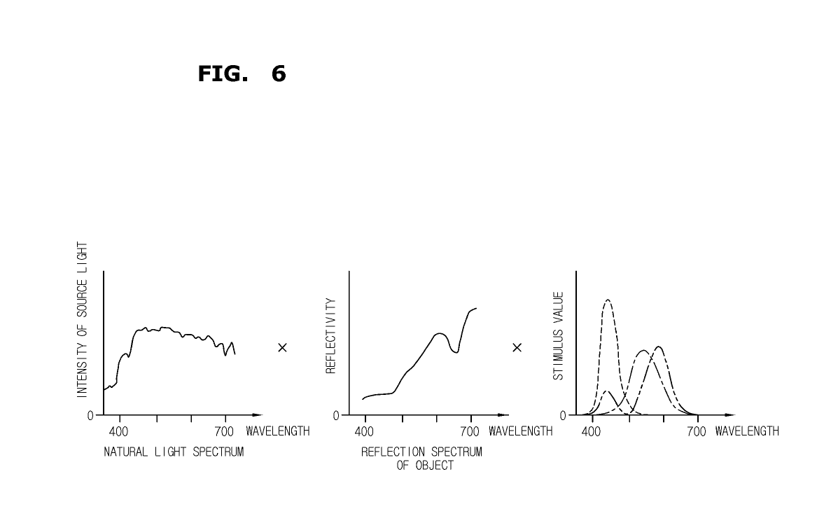

FIG. 6 shows a spectrum of light that has passed a color filter whose bandwidth is widened using the principle.

Referring to FIG. 6, the color filter 150 in accordance with the present disclosure has a wider bandwidth than that of the conventional color filter. It is seen that the light having passed the color filter 150 has a half amplitude wider than that of the light that has passed the conventional color filter.

The half amplitude refers to a width between points at half of the maximum values of a spectrum with a sinusoidal distribution. It may refer to a half width for a wavelength-dependent curve e.g., a transmittance curve.

Referring to FIGS. 3 and 6, since a band pass width of the filter is adjusted to be wider, an overlapping section between spectra in FIG. 6 is wider than in FIG. 3.

In FIG. 3, the green light spectrum and the red light spectrum start to overlap at the points where the transmittance is about 50%, and the overlapping section is widened as the transmittance gets lowered.

By contrast, as shown in FIG. 6, since the bandwidth of the color filter 150 is widened, the overlapping section starts at more than 80% of transmittance and is widened as the transmittance is gradually lowered.

Accordingly, in the case of FIG. 6, unlike in FIG. 3, the passage bandwidth is wider, allowing more amount of light to be transmitted, thereby increasing the overall transmittance of the color filter. With the color filter whose bandwidth is widened, the overall reflectivity of the color filter increases and thus the power efficiency of the reflective display device also increases.

In this case, however, while the transmittance in the color filter increases, the color purity is degraded because of the large overlapping sections of wavelengths of light that have passed the filter. However, in embodiments of the present disclosure, if external source light having high color purity, such as LED light is used, the image may be expressed with high color purity while maintaining the transmittance. This will be described below with reference to related drawings.

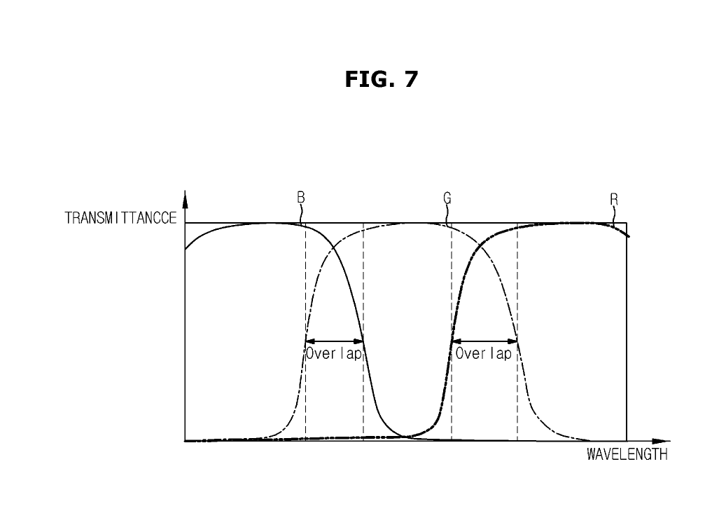

FIG. 7 shows a transmission spectrum of light, which is a mixture of red, green, and blue colors of light with high color purity, such as LED or laser light.

As for natural light, all wavelengths of light are mixed, so it is difficult to tell red, green, and blue from each other, but LED or laser light has spectra of the colors of light, which are not mixed and thus have high color purity, as shown in FIG. 7. Accordingly, the LED or laser is used as a light source for backlighting of a display device.

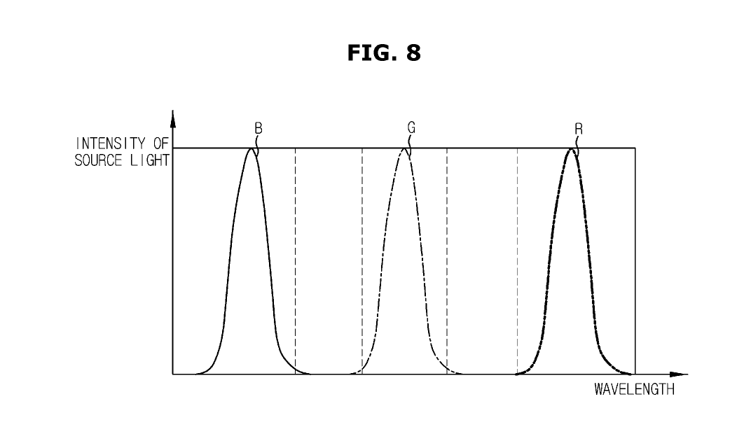

However, in the case of a conventional color filter, color purity is degraded when the LED or laser is used as an external light source. This will be described in connection with FIG. 8.

FIG. 8 shows a spectrum of green light expressed outwardly when a color filter whose thickness is adjusted is used in a reflective display device.

A spectrum of reflected light expressed outwardly is determined by a spectrum of an external source light that has passed a color filter, and accordingly, a spectrum of light that has passed a color filter whose thickness is adjusted is depicted as shown on the far right of FIG. 8.

In this case, the light of green-oriented wavelengths has high transmittance while the transmittance of blue and red colors of light in the spectrum decreases and thus an amount of light is reduced. However, in this case, even though the amount of light of blue and red colors decreases, the spectrum of the blue and red colors overlaps the green light spectrum, which leads to bad color purity.

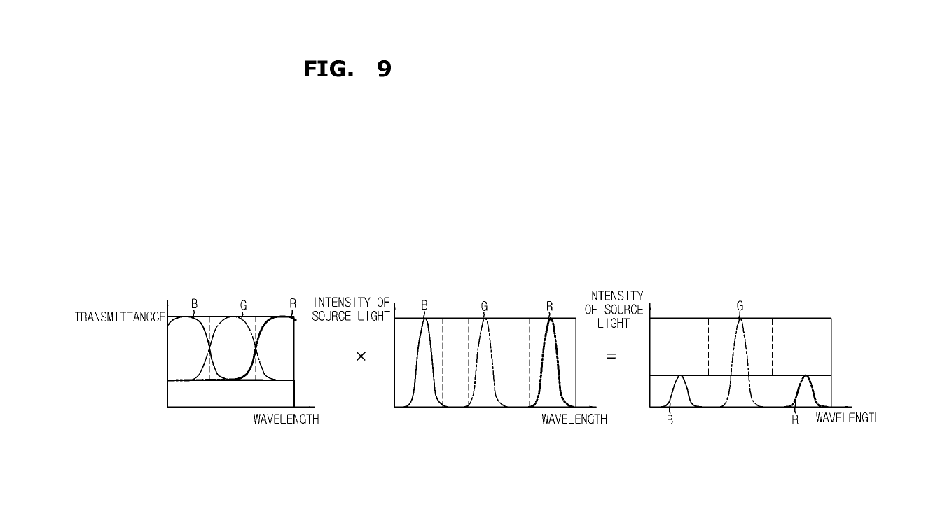

This problem of degradation of color purity may be solved by using a color filter whose bandwidth is widened. This will be described in detail with reference to FIGS. 9 to 12.

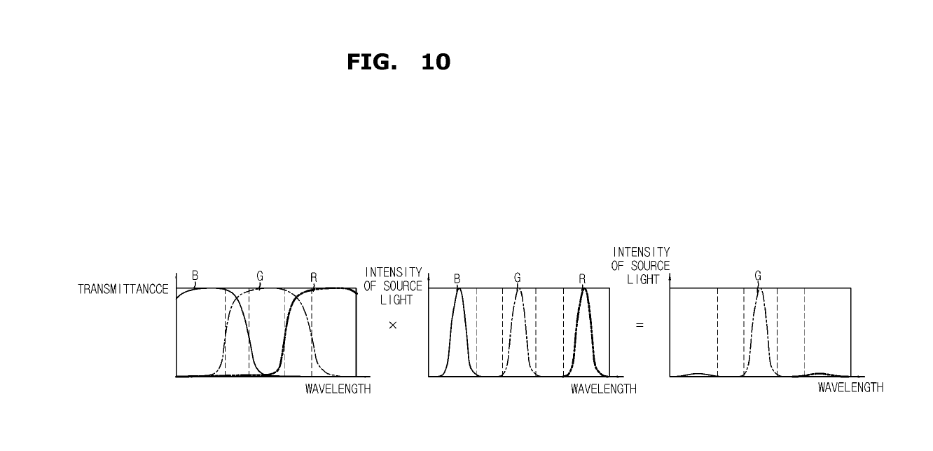

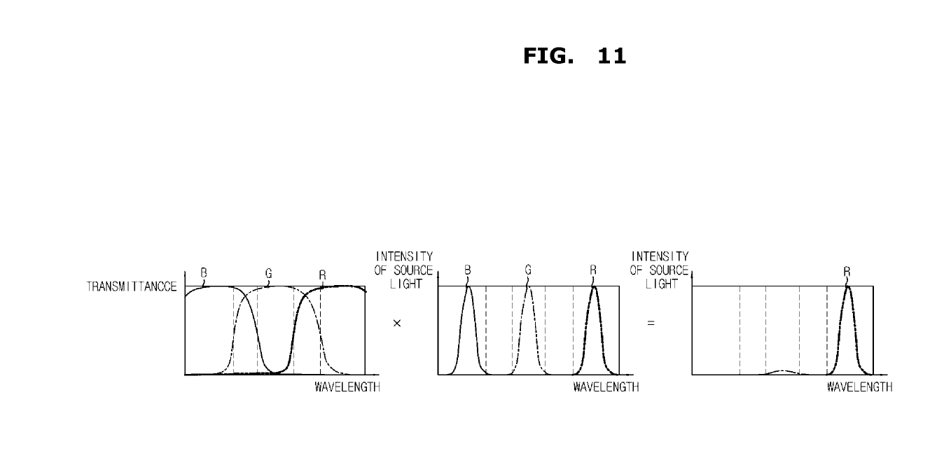

FIG. 9 shows a spectrum of green light that has passed the color filter 150 whose bandwidth is adjusted, FIG. 10 a spectrum of red light, and FIG. 11 a spectrum of blue light, when a light source having high RGB color purity is used as an external light source, according to an embodiment of the present disclosure.

Referring to FIG. 9, the color filter 150 is adjusted to be widened in bandwidth so that an amount of light that has passed the color filter 150 increases. This may lead to an increase in overall reflectivity and efficiency.

Not the thickness but the bandwidth of the color filter 150 is adjusted, so some wavelengths far from the center wavelength do not remain at a certain level of transmittance as shown in FIG. 3 but converge to 0 of transmittance as shown in FIG. 6. Accordingly, the bandwidth of the light that has passed the color filter shows that there is only a spectrum of green light with little red and blue light spectra, as shown in FIG. 9.

In this case, unlike what is shown in FIG. 8, most of the spectra of red and blue light are absorbed by the color filter but only the spectrum of pure green light remains, so an images with high color purity may be expressed outwardly.

FIG. 10 shows a spectrum of red light that has passed the color filter 150 according to a similar principle to that of FIG. 9, thereby having high color purity.

As for the red light, the color filter 150 has high transmittance in a pure red light wavelength band while having low transmittance in blue and green wavelength bands.

When the light having high color purity, such as LED light passes the red filter 151, a spectrum with high color purity for red may be obtained with little existence of blue and green light spectra, as shown in FIG. 10. Accordingly, an image with high color purity may be expressed outwardly.

FIG. 11 shows a spectrum of blue light that has passed the color filter 150 according to a similar principle to those of FIGS. 9 and 10, thereby having high color purity.

As for the blue light, the color filter 150 has high transmittance in a pure blue light wavelength band while having low transmittance in red and green wavelength bands.

When the light having high color purity, such as LED light passes the blue filter 152, a spectrum with high color purity for blue may be obtained with little existence of red and green light spectra, as shown in FIG. 11. Accordingly, an image with high color purity may be expressed outwardly.

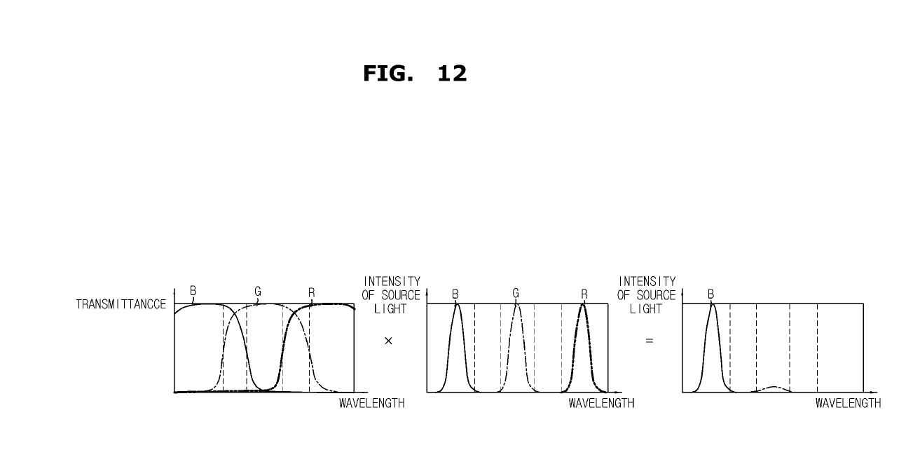

FIG. 12 shows a general spectrum of light that has passed each of the red filter 151, the green filter 152, and the blue filter 153 as described above in connection with FIGS. 9 to 11.

A light source such as an LED with high color purity is used for lighting, so that the spectrum is separately expressed, and the color filter 150 has a wider bandwidth than that of the conventional color filter.

Accordingly, a spectrum of light that has passed the color filter 150 shows high color purity, i.e., separated three colors, as shown on the far right of FIG. 12.

The reflective display device 100 to which the color filter 150 whose bandwidth is widened is applied in accordance with an embodiment of the present disclosure has thus far been described.

A selective display device 300 including the reflective display device 100 in accordance with an embodiment of the present disclosure will now be described.

A selective display device refers to a device serving as both a reflective display device that expresses an image using an external light source and a transmissive display device using a built-in light source to apply light.

The reflective display device has a disadvantage in that expression of a spectrum of light is changed depending on the intensity and color purity of the external light source, as described above. The selective display device may overcome such a disadvantage by performing selective switching between the reflective display device and the transmissive display device.

Specifically, the selective display device may act as the reflective display device to express an image when there is a good external light source, and may act as the transmissive display device to express an image when there is no good external light source, thereby always providing images with good color purity to the user.

The selective display device 300 will now be described in detail in connection with associated drawings.

The selective display device 300 may include the upper plate 110 and the lower plate 120, which are arranged to be separated from each other, the liquid crystal layer 130 arranged between the upper plate 110 and the lower plate 120, the reflective plate 140 arranged under the liquid crystal layer 130, and the color filter 150 arranged on the top of the liquid crystal layer 130 for selectively transmitting predetermined colors of light.

The color filter 150 has a bandwidth, which is wider than the half width of light that passes the color filter 150, and the reflective plate 140 is characterized by being switched between a reflective mode in which light is reflected and a transmissive mode in which light is transmitted.

The upper plate 110, lower plate 120, liquid crystal layer 130 arranged between the upper and lower plates 110 and 120, and color filter 150 arranged on the top of the liquid crystal layer 130 in the selective display device 300 are the same as those in FIG. 11, so the description thereof will not be repeated. An operating principle of the selective display device 300, and the reflective plate 140 and an illumination source 200, which are characteristics of the selective display device 300, will now be described.

Since the selective display device 300 has all the property and characteristics of the aforementioned reflective display device 100, it may operate as described above in connection with FIG. 1 to express an image outwardly when there is a good external light source. However, in a case that there is no good external light source and the resultant image is not good, an extra light source is provided to solve the disadvantage of the reflective display device 100.

Specifically, when the selective display device 300 operates as a transmissive display device, the reflective plate 140 is switched into the transmissive mode in which to transmit external light L1 as it is rather than reflecting the light L1 as in the reflective display device. In this case, the external light L1 is transmitted through the reflective plate 140 as it is, and is not output to the outside. That is, the external source light L1 is not used to express an image.

Instead, the illumination source 200 such as an LED with high color purity serves as a source to supply light.

An operating principle of the illumination source 200 is the same as that of a backlight of a typical transmissive display device. Accordingly, the illumination source 200 may include a light source 210 that emits light and a light guide plate 220.

The light guide plate 220 may include a planar member such as PMAA, PC, or the like, manufactured of a transmissive material.

The light guide plate 220 may include a side face 230 on which the light is incident from the light source 210, and a front face 240 and a rear face 250, which are perpendicular to the side face 230. The front face 240 and the rear face 250 may be arranged to face each other. At least one of the front face 240 and the rear face 250 of the light guide plate 220 may include a light guide means 260 to guide the incident light that enters through the side face 230 to the front side 240. The light guide means 260 may have a scattering pattern, a diffractive pattern, and/or the like.

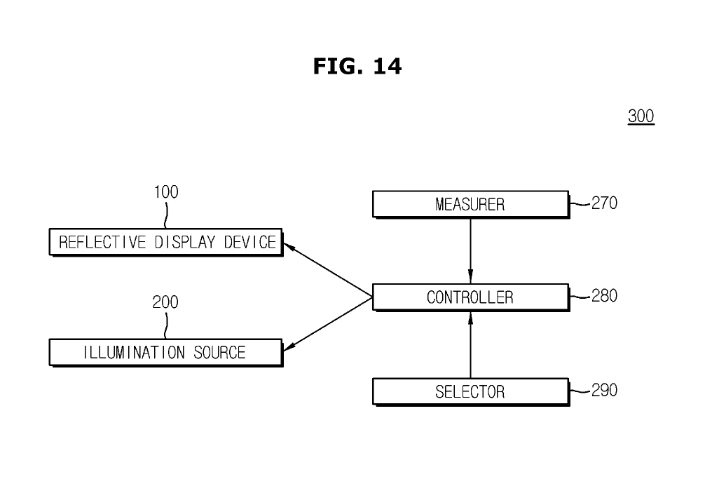

The illumination source 200 may be located in the back as shown in FIG. 14. It is not, however, limited thereto, and the illumination source 200 may be located in front in consideration of the characteristics of the reflective display device.

An LED or laser may be used as the light source 210.

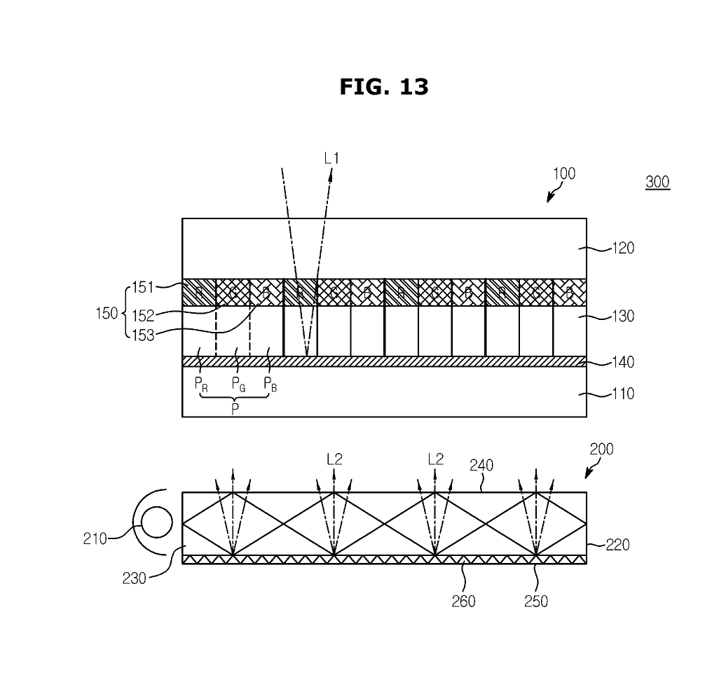

Referring to FIG. 13, regarding an operating principle of the selective display device 300, illuminated light L2 enters into the filter area 150 from the illumination source 200, in which case the light is not reflected but transmitted through the reflective plate 140 that has been switched into the transmissive mode.

Subsequently, when the illuminated light L2 enters into the filter area 150, the light in the wavelength bands corresponding to the sub-filter areas 151, 152 and 153 is transmitted while the light in the other wavelength band is absorbed, thereby forming red R, green G, and blue B light. The red R, green G, and blue B light may or may not be transmitted through the liquid crystal layer 130 depending on the liquid crystal layer 130 being electrically controlled to be on or off. The light that has been transmitted through the liquid crystal layer 130 is emitted to the outside, and an image may be expressed in this principle.

The operating principle of the selective display device 300 has thus far been described in connection with FIG. 13. Configuration and operation sequence of the selective display device 300 will now be described in connection with FIG. 14.

Referring to FIG. 14, the selective display device 300 in accordance with an embodiment of the present disclosure may include the reflective display device 100, the illumination source 200, a measurer 270, and a selector 290.

The reflective display device 100 are described above in connection with FIGS. 1 to 12 and the illumination source 200 is described above in connection with FIG. 13, so the description thereof will not be repeated.

The measurer 270 may measure a spectrum of external source light. In which mode the selective display device 300 is operated is determined based on the spectrum of the external source light, so the measurer 270 measures the spectrum of the external source light and sends the measurement to the controller 280.

The controller 280 may control the reflective plate 140 and the illumination source 200 based on the spectrum of the external source light measured by the measurer 270.

Specifically, the controller 280 analyzes the spectrum of the external source light measured by the measurer 270, and if it is determined that the spectrum of the external source light has a first type based on the analysis, switch the reflective plate 140 into the reflective mode and powers off the illumination source 200.

The first type refers to an occasion when the spectrum of the external source light has good color purity and an amount of light is sufficient, i.e., when a good enough image may be expressed in the reflective mode.

In this case, since there is no need to activate the illumination source 200, the reflective plate 140 is switched into the reflective mode and the illumination source 200 is turned off, outputting an image in the reflective mode. This gives an advantage of expressing an image outwardly with good color purity without using the illumination source 200.

Otherwise, if the controller 280 determines that the spectrum of the external source light has a second type based on the analysis of the spectrum of the external source light measured by the measurer 270, it switches the reflective plate 140 into the transmissive mode and powers on the illumination source 200.

The second type refers to an occasion when the spectrum of the external source light has poor color purity and an amount of light is not sufficient, i.e., when an image with good color purity may not be expressed only with the reflective display device. Accordingly, in this case, it is switched into the transmissive mode to express an image outwardly.

It may supplement the shortcomings of the reflective display device that depends on the external light source, and always give an image with good color purity to the user.

The selector 290 may allow the user to select whether to use the reflective mode or the transmissive mode.

Specifically, even in the reflective mode determined by the controller 280, the selector 290 may allow the user to switch to the transmissive mode to his/her liking to express an image in the transmissive mode, thereby forming an image that is more suitable to the taste of the user.

Features and benefits of the present disclosure have thus far been described in connection with various embodiments of the present disclosure.

The conventional reflective display device increases the reflectivity by adjusting thickness of the color filter but suffers from color purity degradation.

However, in the embodiments of the present disclosure, the reflectivity is increased by widening a passage bandwidth of the color filter instead of adjusting the thickness of the color filter, so that the power efficiency is improved and an image with high color purity may be expressed. Furthermore, it is possible to select between reflective mode and transmissive mode depending on the ambient environment, thereby providing goo quality of images to the user in a more stable manner.

According to embodiments of the present disclosure, a reflective display device may have improved energy efficiency and provide images with high color purity by increasing reflectivity of the reflective display device. Furthermore, the display device may select its operation method between reflective and selective modes according to ambient environments, thereby provide images with large color gamut for the user in a stable manner.

Although the present disclosure is described with reference to some embodiments as described above and accompanying drawings, it will be apparent to those ordinary skilled in the art that various modifications and changes can be made to the embodiments. For example, the aforementioned method may be performed in different order, and/or the aforementioned systems, structures, devices, circuits, etc., may be combined in different combinations from what is described above, and/or replaced or substituted by other components or equivalents thereof, to obtain appropriate results. Therefore, other implementations, other embodiments, and equivalents thereof may fall within the following claims.

What is claimed is:

1. A reflective display device comprising:
two plates arranged to be separated from each other;
a liquid crystal layer arranged between the two plates;
a reflective plate arranged under the liquid crystal layer; and
a color filter arranged on the top of the liquid crystal layer and configured to selectively transmit a predetermined color of light,
wherein the color filter has a bandwidth wider than a half width of light that passes through the color filter.

2. The reflective display device of claim 1, wherein the color filter comprises one of a red color filter, a green color filter, and a blue color filter.

3. The reflective display device of claim 2, wherein the color filter has transmittance of equal to or greater than about 50% and equal to or less than about 80% at a point where spectra of green light and red light that have passed the color filter cross.

4. The reflective display device of claim 2, wherein transmittance of the color filter has transmittance of equal to or greater than about 50% and equal to or less than about 80% at a point where spectra of green light and blue light that have passed the color filter cross.

5. The reflective display device of claim 2, wherein a bandwidth of the green color filter is wider than a half width of green light that passes the green color filter, the half width being equal to or greater than about 120 nm and equal to or less than 160 nm.

6. The reflective display device of claim 2, wherein a bandwidth of the red color filter is wider than a half width of red light that passes the red color filter, the half width being equal to or greater than about 120 nm and equal to or less than 160 nm.

7. The reflective display device of claim 2, wherein a bandwidth of the blue color filter is wider than a half width of blue light that passes the blue color filter, the half width being equal to or greater than about 120 nm and equal to or less than 160 nm.

8. A selective display device comprising:
two plates arranged to be separated from each other;
a liquid crystal layer arranged between the two plates;
a reflective plate arranged under the liquid crystal layer;
a color filter arranged on the top of the liquid crystal layer and configured to selectively transmit a predetermined color of light; and
an illumination source arranged under the reflective plate and configured to supply light to the liquid crystal layer,
wherein the color filter has a bandwidth wider than a half width of light that passes through the color filter, and the reflective plate is switched between a reflective mode in which the light is reflected and a transmissive mode in which the light is transmitted.

9. The selective display device of claim 8, further comprising: a measurer configured to measure a spectrum of light emitted from an external light source.

10. The selective display device of claim 9, further comprising: a controller configured to control intensity of the illumination source and operation of the reflective plate.

11. The selective display device of claim 10, wherein the controller is configured to control the intensity of the illumination source and operation of the reflective plate according to a feature of the spectrum measured by the measurer.

12. The selective display device of claim 11, wherein the controller is configured to switch the reflective plate into the reflective mode and power off the illumination source when determining that the feature of the spectrum measured by the measurer corresponds to a first type.

13. The selective display device of claim 11, wherein the controller is configured to switch the reflective plate into the transmissive mode and power on the illumination source when determining that the feature of the spectrum measured by the measurer corresponds to a second type.

14. The selective display device of claim 9, further comprising: a selector configured to allow a user to select intensity of the illumination source and operation of the reflective plate.

15. The selective display device of claim 9, wherein the illumination source comprises a light emitting diode (LED) or laser.
